(19) United States
(12) Patent Application Publication
(10) Pub. No.: US 2014/0156482 A1
(43) Pub. Date: Jun. 5, 2014

(54) FINANCIAL APPARATUS, METHOD AND SYSTEM FOR CONTROLLING THE APPARATUS

(71) Applicant: LG CNS CO., LTD., Seoul (KR)

(72) Inventors: So Young KIM, Incheon (KR); Dong Eek RHEE, Seoul (KR)

(73) Assignee: LG CNS CO., LTD., Seoul (KR)

(21) Appl. No.: 14/092,200

(22) Filed: Nov. 27, 2013

(30) Foreign Application Priority Data
Nov. 30, 2012 (KR) 10-2012-0138489
Nov. 30, 2012 (KR) 10-2012-0138490

(51) Int. Cl. G06Q 40/02; H04L 29/08

(52) U.S. Cl. CPC G06Q 40/02; H04L 67/04
USPC 705/35

(57) ABSTRACT

The present disclosure relates to a financial apparatus, and a method and a system for controlling the apparatus. The financial apparatus is embodied so that, if a service request is received from at least one teller terminal, a determination part determines a service type from the received service request, and a controlling part performs an occupied service process or an unoccupied service process according to the determined service type, and thus the service requests can be processed in parallel. Due to the parallel processing, task processing efficiency can be maximized and also waiting time can be reduced.

### CROSS-REFERENCE TO RELATED APPLICATIONS

This application claims the benefit under 35 U.S.C. §119 of Korean Patent Application Nos. 10-2012-0138490 filed Nov. 30, 2012 and 10-2012-0138489, filed Nov. 30, 2012, which are hereby incorporated by reference in their entirety.

### BACKGROUND

The present disclosure relates to a financial apparatus, and a method and a system for controlling the apparatus.

A financial apparatus for tellers is an automated teller machine (ATM) which is installed in a working space of tellers in order to perform various tasks such as a cash-based business and a balance inquiry business, and it is also called a teller cashier recycler (TCR). Typically, the financial apparatus for tellers is shared and used by two tellers. However, while the financial apparatus for tellers is already being used by one teller, the other teller cannot use the financial apparatus for tellers regardless of the type of services. When the one teller finishes the use of the financial apparatus for tellers, the other teller should checks whether the use of the financial apparatus for tellers is finished, should requests the use of the financial apparatus for tellers, and then can uses the financial apparatus for tellers. Therefore, since the two tellers cannot use the financial apparatus for tellers at the same time, regardless of the type of services, waiting time of the tellers who want use the financial apparatus for tellers is too long, and service processing efficiency is very low.

Furthermore, since the general financial apparatus for tellers is embodied to be used by two tellers, it is impossible to allow three or more tellers including another teller at a distance to use the financial apparatus for tellers, and thus the efficiency in terms of operation rate of the apparatus is also low.

### BRIEF SUMMARY

Various embodiments of the present disclosure are directed to providing a financial apparatus which can process multiple service requests from multiple tellers in parallel, and a method and a system for controlling the apparatus.

Various embodiments of the present disclosure are directed to providing a financial apparatus which can process a service from a remote teller terminal, and a method and a system for controlling the apparatus.

According to an embodiment of the present disclosure, a financial apparatus includes: a transmitting/receiving part configured to receive a service request from at least one teller terminal and transmits a state message corresponding to the received service request to the teller terminal; and a controlling part configured to determine whether it is in a state capable of performing a service, when the service request is received, and output a service performing possibility message to the transmitting/receiving part, if it is in a state capable of performing the service, and output a standby message to the transmitting/receiving part, if it is in a state not capable of performing the service.

According to another embodiment of the present disclosure, a financial apparatus includes: a determination part configured to receive a service request from at least one teller terminal and determine a service type from the received service request; a controlling part configured to perform an occupied service process or an unoccupied service process according to the determined service type; and a service processing information storing part configured to store information of the performed service, wherein, when service performance is finished, the controlling part transmits information of finishing the service performance to the teller terminal which transmits the service request and also updates service processing information in the service processing information storing part in real time.

According to another embodiment of the present disclosure, a method of controlling a financial apparatus includes: receiving a service request from at least one teller terminal; determining a service type from the received service request; and performing an occupied service process by a controlling part according to the determined service type, wherein the performing of the occupied service process includes outputting a command for performing the occupied service by a performing part according to the received service request and performing the requested occupied service; transmitting information of finishing the service performance to the teller terminal which transmits the service request when the service is finished; and updating service processing information in the service processing information storing part by the controlling part in real time.

The details of one or more embodiments are set forth in the accompanying drawings and the description below. Other features will be apparent from the description and drawings, and from the claims.

### BRIEF DESCRIPTION OF THE DRAWINGS

FIG. 1 is a schematic view of a control system of a financial apparatus for tellers according to an embodiment of the present disclosure.

FIG. 2 is a block diagram showing construction components of a financial apparatus for tellers according to the embodiment of the present disclosure.

FIG. 3 is a flow chart showing a method of controlling the financial apparatus for tellers according to the embodiment of the present disclosure.

FIG. 4 is a flow chart showing another method of controlling the financial apparatus for tellers according to the embodiment of the present disclosure.

FIG. 5 is a block diagram showing components of a financial apparatus for tellers according to another embodiment of the present disclosure.

FIG. 6 is a flow chart showing a method of controlling the financial apparatus for tellers according to the other embodiment of the present disclosure.

FIG. 7 is a swimlane diagram showing another method of controlling the financial apparatus for tellers according to the other embodiment of the present disclosure.

FIG. 8 is a swimlane diagram showing a further another method of controlling the financial apparatus for tellers according to the other embodiment of the present disclosure.

### DESCRIPTION OF EMBODIMENTS

Now, embodiments of the present disclosure will be described in detail with reference to the accompanying drawings. It should be understood that the same reference numerals are given to the same or corresponding parts, even though they are illustrated in different drawings. Further, in the description of the embodiments of the present disclosure, if it is considered that the specific description of the related and noticed functions or structures may obscure the comprehension of the present disclosure, the description thereof will not be omitted.

Furthermore, in the description of construction components of the present disclosure, terms or letters “first” “second”, “A”, “B” “(a)” and “(b)” may be used. These terms or letters are used only to distinguish the components and not used to limit their intrinsic attributes, order or the like. It is to be noted that, in this specification, the expression that “a certain construction component is connected or coupled to another construction component” means that the certain construction component is directly connected to another construction component, and also means that a third construction component may be interposed therebetween.

A financial apparatus according to embodiments of the present disclosure will be described by using a financial apparatus for tellers as an example, but not limited to this.

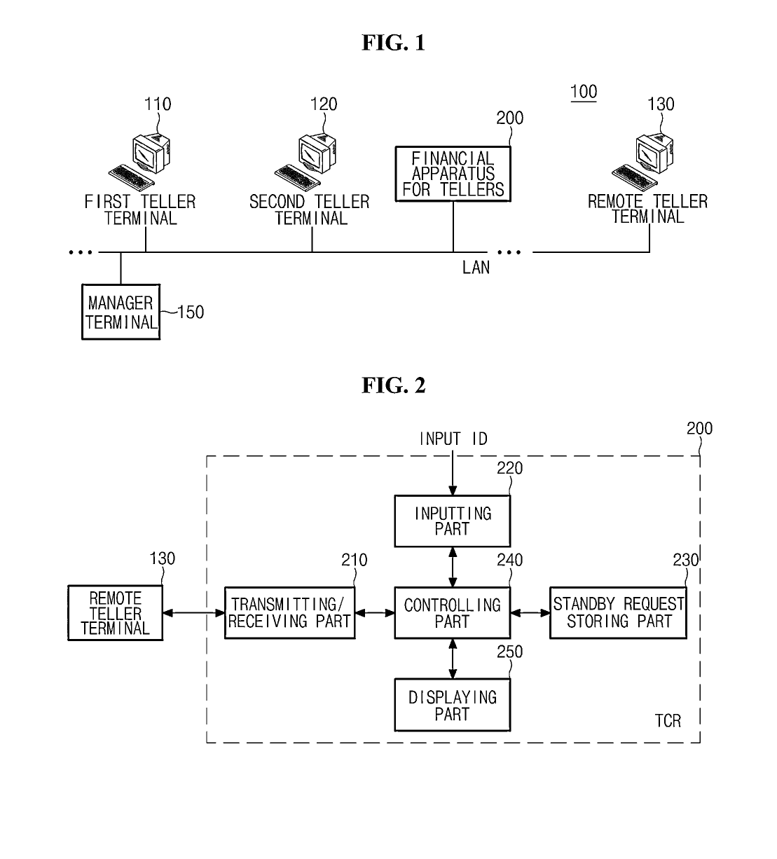

FIG. 1 is a schematic view of a control system of a financial apparatus for tellers according to an embodiment of the present disclosure.

Referring to FIG. 1, a control system 100 of a financial apparatus for tellers of the present disclosure includes at least one teller terminal 110, 120, 130, a financial apparatus 200 for tellers, which is used by the teller terminal 110, 120, 130, and a manager terminal 140 which manages the financial apparatus 200 for tellers.

In the conventional art, only two teller terminals (e.g., a first teller terminal 110 and a second teller terminal 120 of FIG. 1) could share the financial apparatus 200 for tellers. However, the embodiment of present disclosure is embodied so as to process a service requested by a remote teller terminal 130. The teller terminal 110, 120, 130, financial apparatus 200 for tellers and manager terminal 140 may be connected to each other through a wired network such as a LAN for transmitting/receiving data or a wireless network such as WiFi and Bluetooth.

The first teller terminal 110, second teller terminal 120 and remote teller terminal 130 which are used by tellers may be embodied in the form of a personal computer or a potable terminal such as a smart pad and a tablet PC.

In FIG. 1, the first and second teller terminals 110 and 120 are directly connected to the financial apparatus 200 for tellers, and the remote teller terminal 130 is wirelessly connected to the financial apparatus 200 for tellers. However, all of the teller terminals 110, 120 and 130 may be connected through a wired network or a wireless network. The communication network includes a NFC (Near Field Communication) network, a LAN (Local Area Network), a WAN (Wide Area Network), the Internet and so on.

The teller terminals 110, 120 and 130 operate the financial apparatus 200 for tellers and check the state of the financial apparatus 200 for tellers, available money and so on. Further, each of the teller terminals 110, 120 and 130 may include or be connected to a counting indicator (not shown). The counting indicator may be embodied as a monitor or tablet PC allowing a customer to check the state of counting banknotes in real time or the like.

The manager terminal 140 is connected with the financial apparatus 200 for tellers and the multiple teller terminals 110, 120 and 130. The manager terminal 140 allowing a manager to monitor the state of the financial apparatus 200 for tellers, available money and so on in real time may be provided in the form of a mobile PC or a general PC.

The financial apparatus 200 for tellers, which may be an automated teller machine (ATM) for tellers, may perform various functions of calculating and storing a counted number for each kind of banknote deposited and withdrawn, distinguishing counterfeit money, performing inquiry services and so on through operation of the teller terminals or tellers.

A service performed by the financial apparatus 200 for tellers may be divided into an operating service, such as deposit and withdrawal money, performed with operation of a internal module in the financial apparatus, and a non-operating service, such as inquiry service, performed without the operation of the internal module in the financial apparatus. For example, the internal module may be a deposit/withdrawal processing module, a card reader module, a banknote printer module, a near field communication (NFC) module and so on.

Further, in the service performed by the financial apparatus 200 for tellers, the operating service may be corresponding to an occupied service, and the non-operating service may be corresponding to an unoccupied service, in the aspect of requiring occupancy of the internal module of the financial apparatus 200 for tellers.

In the conventional art, when two teller terminals (e.g., a first teller terminal 110 and a second teller terminal 120 of FIG. 1) share the financial apparatus 200 for tellers and request services, one service is performed after the other service is finished, regardless of the type of the services, and thus waiting time for service processing is too long and task efficiency is low. However, because the financial apparatus 200 for tellers according to an embodiment of the present disclosure may process two or more services in parallel, it is possible to improve the task efficiency and reduce the waiting time. In other words, in the conventional art, the service requests from the teller terminals are performed in turn. However, the financial apparatus 200 for tellers according to the embodiment of the present disclosure may process the service requests from two or more teller terminals in parallel.

More detailedly, when a general financial apparatus for tellers is performing a service requested by a first teller terminal, it is impossible to receive or perform other service requests. Only after the service requested by the first teller terminal, it is possible to receive and perform other service request from a second teller terminal. In order to solve the limitation, when a service request is received from at least one teller terminal 110, 120, 130, the financial apparatus 200 for tellers according to the embodiment of the present disclosure determines whether the received service is the occupied service or unoccupied service. And if the received service is the unoccupied service, the financial apparatus 200 for tellers immediately obtains information from a service processing information storing part and sends a response, and if it is the occupied service, a controlling part performs the service through a performing part.

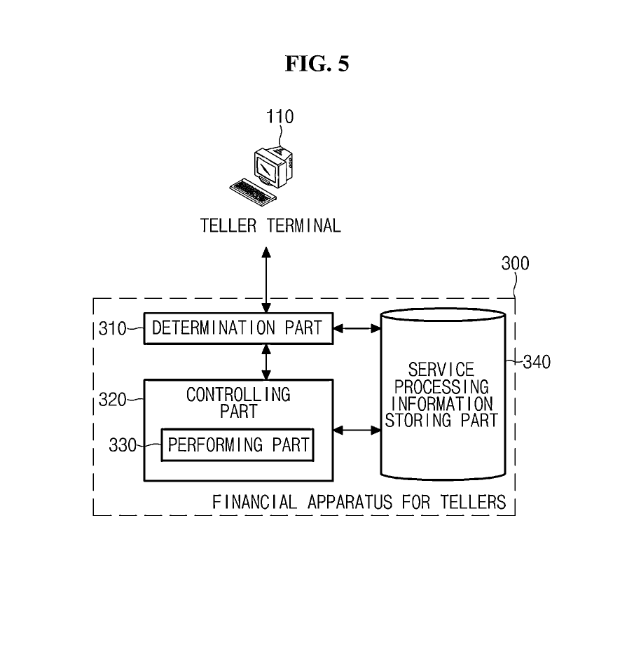

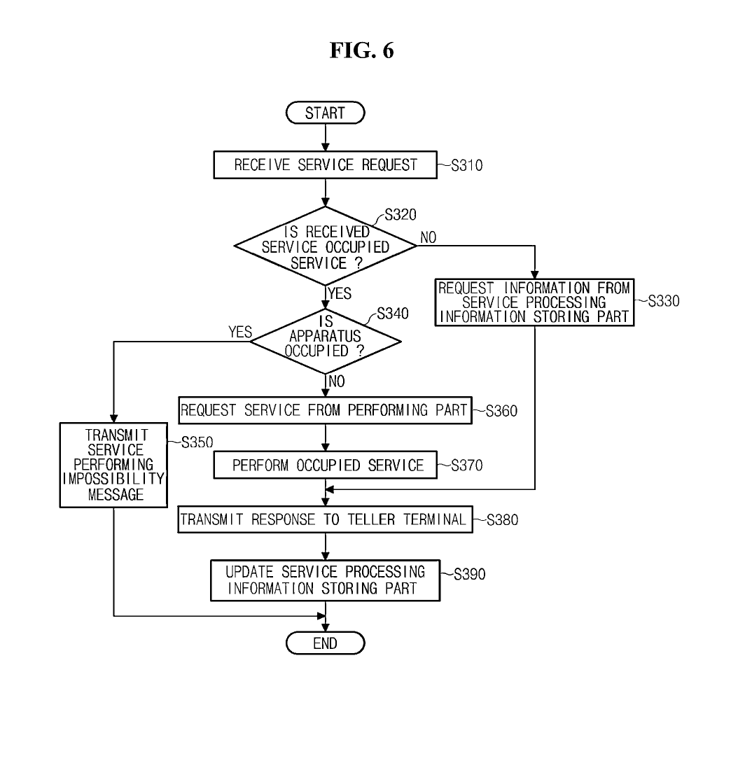

Therefore, since the financial apparatus 200 for tellers according to the embodiment of the present disclosure changes a processing way according the type of services, it is possible to perform parallel and efficient task processing. The configuration and operation of the financial apparatus 200 for tellers according to the embodiment will be described more fully with reference to FIGS. 5 to 8.

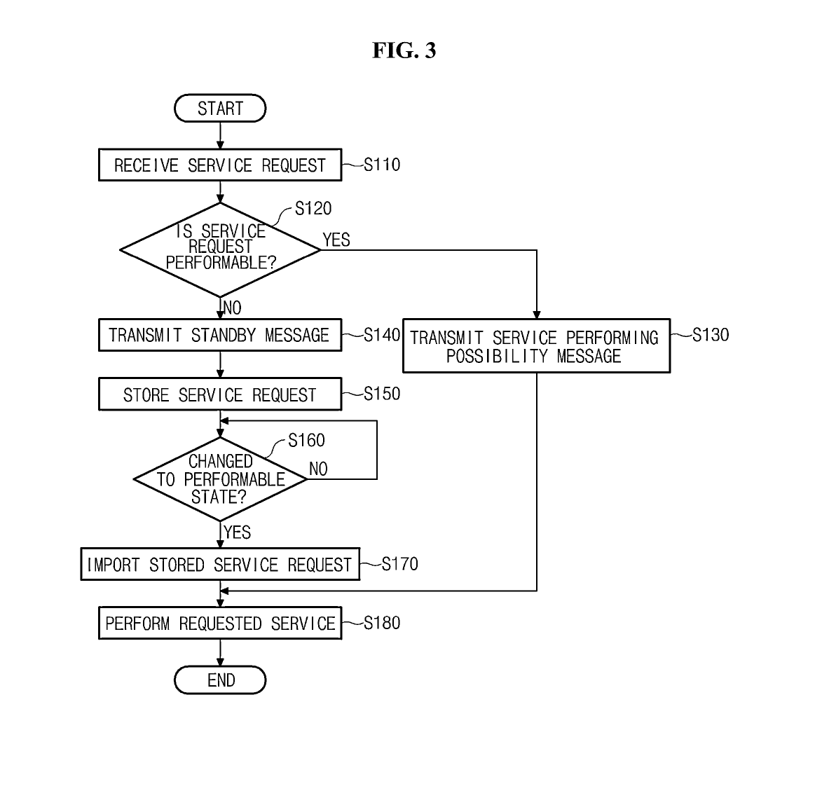

Further, in order to solve the above-mentioned limitation, when a service request is received from at least one teller terminal 110, 120, 130, the financial apparatus 200 for tellers of the present disclosure checks whether it is possible to perform the service and then transmits a state message. Otherwise, the financial apparatus 200 for tellers transmits a standby message and stores, in turn, the service requests which may not be performed now and then outputs and performs the service requests one by one when being in the state capable of performing the services. Thus, the financial apparatus 200 for tellers according to the embodiment of the present disclosure may process the service requests from multiple teller terminals, thereby improving the task processing efficiency. The configuration and operation of the financial apparatus 200 for tellers according to the embodiment will be described more fully with reference to FIGS. 2 to 4.

The control system 100 of the financial apparatus for tellers of the present disclosure informs the state of the financial apparatus to the teller terminals 110, 120 and 130 using a service performing possibility message or standby message, and even though it is impossible to perform the service request in real time, it may store the service request and then may process it later. Therefore, the control system 100 of the financial apparatus for tellers of the present disclosure allows remote processing through the remote teller terminal 130 and also allows the tellers requesting the service to monitor the state of the financial apparatus 200 for tellers through the state message, thereby efficiently performing the task processing.

FIG. 2 is a block diagram showing construction components of a financial apparatus for tellers according to an embodiment of the present disclosure.

The financial apparatus 200 for tellers according to the embodiment of the present disclosure includes a transmitting/receiving part 210 which transmits/receives data to/from the teller terminal (e.g., the remote teller terminal 130 of FIG. 1), an inputting part 220 through which a teller directly inputs its own ID, a standby request storing part 230 which stores service requests previously processed, a displaying part 250 which displays a work in progress and a controlling part 240 which controls these parts. The financial apparatus 200 for tellers may manage and process the service requests from multiple tellers.

The drawing shows that the financial apparatus 200 for tellers is connected with one teller terminal 130 so as to be operated. However, the financial apparatus 200 for tellers may transmit/receive data to/from two or more teller terminals (e.g., which are directly connected or located at a distance).

The transmitting/receiving part 210 receives a service request from the remote teller terminal 130, determines whether the financial apparatus 200 for tellers may perform the service request and then transmits a state message to the remote teller terminal 130. In other words, the transmitting/receiving part 210 transmits the service request received from the remote teller terminal 130 to the controlling part 240, receives the state message from the controlling part 240 and then responds (transmits) to the remote teller terminal 130 which transmits the service request. Further, the transmitting/receiving part 210 transmits and receives data necessary to perform the service between the financial apparatus 200 for tellers and the remote teller terminal 130, e.g., reports a result after completion of the service processing.

When receiving the service request from at least one teller terminal (e.g., 130), the controlling part 240 determines whether the financial apparatus 200 for tellers is in the state capable of performing the service. For example, when the financial apparatus 200 for tellers is performing an occupied service, it may be determined that the financial apparatus 200 for tellers is in the state capable of performing the service.

As a result of the determination, if the financial apparatus 200 for tellers is in the state capable of performing the service, the service performing possibility message is output to the transmitting/receiving part 210, and if the financial apparatus 200 for tellers is in the state not capable of performing the service, the standby message is output to the transmitting/receiving part 210. The output service performing possibility message and standby message which are a state message of the financial apparatus 200 for tellers are transmitted to the teller terminal (e.g., 130) which transmits the service request.

Herein, the controlling part 240 does not perform the service immediately after receiving the service request. Instead, the controlling part 240 checks the current state and then outputs the service performing possibility message (or message informing the start of performance) or standby message, such that the teller terminal 130 may monitor whether the service is performed.

If it is impossible to perform the received service request, the controlling part 240 transmits the standby message and then stores, in turn, the service requests in the standby request storing part 230. The standby request storing part 230 is to perform a queue management function of storing unprocessed ones out of the received service requests. When there is limitation to perform the service with respect to the multiple service requests, the standby request storing part 230 stores temporarily the service requests.

In other words, the controlling part 240 performs the first to receive and then stores other service requests, which are received during the performance, in the standby request storing part 230. Then, if the service performance is finished, the controlling part 240 is changed from the ‘unperformable state’ into the ‘performable state’, imports the service request from the standby request storing part 230 and then performs the next service. As an embodiment, the controlling part 240 may import the waiting service requests in their order, i.e., in a first-in first-out manner in which the foremost input (stored) service request is firstly output.

In the embodiment, as described above, because the service requests from the short-distance teller terminal (e.g., 110, 120) and the remote teller terminal 130 are queue-managed, it is possible to solve the limitation in the general financial apparatus for tellers, in which only one service may be performed. Further, because the remote teller terminal 130 may also share the financial apparatus 200 for tellers, it has a great effect on cost reduction.

Further, when it is possible to perform the received service, the controlling part 240 performs the service. Herein, a controlling method of the financial apparatus 200 for tellers is changed according to the requested service type. That is, if the requested service is the ‘operating service’, the controlling part 240 transmits an executive command to the internal modules in order to perform the service, and if the requested service is the ‘non-operating service’, the controlling part 240 transmits the service performing possibility message and then immediately transmits requested information. The difference in the performing process for each service will be further described with reference to FIG. 4.

Furthermore, even when it is impossible to perform the received service, the controlling part 240 may perform the unoccupied one of the requested services. In order to perform the unoccupied service, the controlling part 240 controls the internal modules.

As described above, the inputting part 220 is a unit for receiving a teller ID. For example, the inputting part 220 may include buttons, a touch screen and a key board type input device.

In addition, the financial apparatus 200 for tellers may further include a cash receiving part (not shown) for depositing and withdrawing cashes, and a displaying part 250. The displaying part 250 is a unit for displaying processed information of a teller's task which is being performed now. For example, the displaying part 250 may be a display window such as an LCD window. The displaying part 250 functions to display various information about the service type and the teller and teller terminal that request the processing service.

As described above, since the state message of the financial apparatus 200 for tellers with respect to the received service requests is transmitted to the remote teller terminal 130, the remote teller terminal 130 may receive real-time feedback on the service request, and thus it is possible to make an estimate on the service performance. Moreover, in the conventional art, the teller terminal 110, 120, 130 could not request a service during the service performance, and the service had to be requested again after the service performance was finished. However, in the present disclosure, this limitation may be solved by the queue management of the service requests, thereby increasing the task processing efficiency.

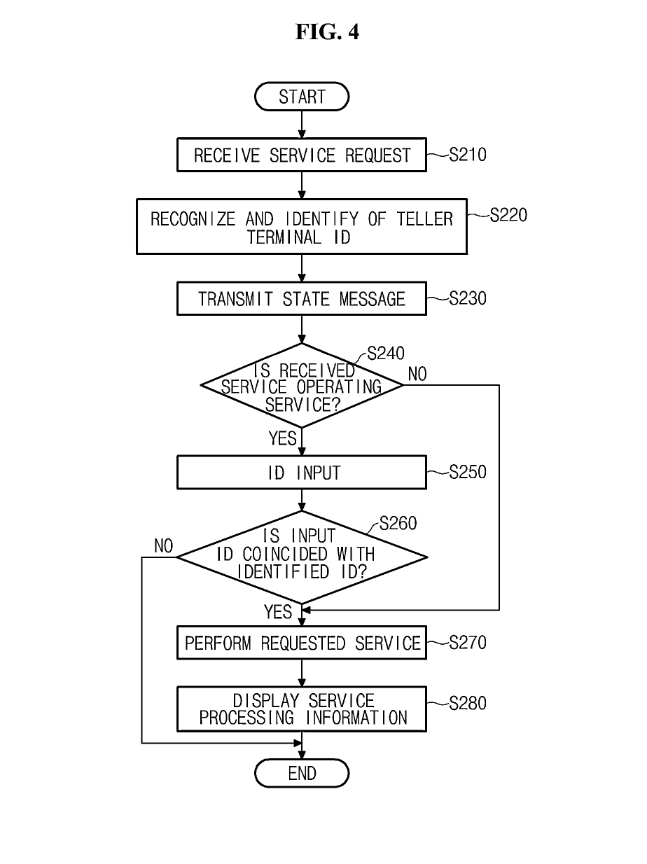

FIG. 3 is a flow chart showing a method of controlling the financial apparatus for tellers according to the embodiment of the present disclosure. For convenience of explanation, it will be described with reference to the configuration of FIGS. 1 and 2.

In FIG. 3, the method of controlling the financial apparatus for tellers will be described by using a flow chart showing the operation of the financial apparatus 200 for tellers with respect to at least one teller terminal 110, 120, 130.

First of all, at least one teller terminal 110, 120, 130 connected with the financial apparatus 200 for tellers through a communication network may transmit a service request which may be the operating service or non-operating service, and the financial apparatus 200 for tellers receives the service request (S110). When the service request is received, the controlling part 240 of the financial apparatus 200 for tellers checks whether the financial apparatus 200 for tellers is in the state capable of performing the service (S120).

If the financial apparatus 200 for tellers is in the state capable of performing the service, the controlling part 240 transmits the service performing possibility message (S130) and then gives a command for performing the requested service (S180).

However, if the financial apparatus 200 for tellers is in the state not capable of performing the service, the controlling part 240 transmits the standby message (S140) and then stores the service request in the standby request storing part 230 (S150). Herein, the step S140 and step S150 may be occurred at the same time, or may be occurred reversely. The stored service request may be stored in a standby state until a signal is transmitted from the controlling part 240.

Then, after the service performance is finished, the financial apparatus 200 for tellers is changed from the ‘unperformable state’ into the ‘performable state’, and the controlling part 240 imports the service request stored in the standby request storing part 230 (S170). In one embodiment, when the state is changed, the controlling part 240 automatically imports the service request and then immediately performs the service (S180). In the other embodiment, when the state is changed, the controlling part 240 imports the service request, transmits the service performing possibility message and then performs the service.

As described above, in the controlling method of the financial apparatus for tellers according to the embodiment, because the state change is informed to the teller terminal, the teller terminal may previously make an estimate on the service performance. Further, in the controlling method of the financial apparatus for tellers according to the embodiment, if the teller terminal processes the service through another way, it may be embodied to cancel the service performance, thereby preventing unnecessary service performance. This service performance process may be changed according to the requested service type, and it will be described more fully with reference to FIG. 4.

FIG. 4 is a flow chart showing another method of controlling the financial apparatus for tellers according to the embodiment of the present disclosure.

As described above, the service performed by the financial apparatus for tellers may be divided into the operating service and the non-operating service. Due to the nature of financial transactions, in order to ensure security and accuracy, an additional operation may be required according the kind of transactions (services).

Firstly, the financial apparatus 200 for tellers may receive the service request from at least one teller terminal 110, 120, 130 (S210). In an embodiment, the service request may include an ID which is previously provided to each teller terminal.

The controlling part 240 of the financial apparatus 200 for tellers recognizes the ID from the received service request and then identifies whether the ID exists in a previously stored teller ID list (S220).

And then, like in the controlling method of FIG. 3, it is determined whether the financial apparatus 200 for tellers is capable of performing the services, and then the state message (i.e., the service performing possibility message or service performing impossibility message) is transmitted to the teller terminal (S230). The step S220 and step S230 may be occurred at the same time, or may be occurred reversely.

After transmitting the state message, the controlling part 240 checks the service type (S240). That is, it is determined whether the service is the operating service or the non-operating service.

If the service is the non-operating service (e.g., inquiry service), the controlling part 240 performs the received service request regardless of the present state of service performance (i.e., regardless of whether the financial apparatus 200 for tellers is used by another teller terminal), and then displays processing service information and teller information (S279, S280). If the service is finished, the processed result (e.g., the result of inquiry) may be confirmed through the teller terminal 110, 120, 130.

However, in an embodiment, if the service is the operating service, the controlling part 240 may receive an input ID input through the inputting part 220 by a teller (S250). In other words, the teller of the teller terminal which receives the service performing possibility message from the financial apparatus 200 for tellers checks the responding message and then inputs the input ID into the financial apparatus 200 for tellers.

For the input ID received through the inputting part 220, the controlling part 240 determines whether the input ID is coincided with the ID recognized from the service request (S260). This is to ensure security and accuracy of the task and also to prevent occurrence of trouble in the task even when multiple services are processed.

If the controlling part 240 confirms that the input ID is coincided with the ID recognized from the service request, it is also confirmed that the teller who operates the financial apparatus 200 for tellers is the teller who requests the operating service.

Therefore, the financial apparatus 200 for tellers performs the requested service (S270) and displays the processing service information, teller information and so on (S280).

As described above, in the controlling method of the financial apparatus for tellers according to the embodiment, when the requested service is the operating service, it is confirmed whether the teller who operates the financial apparatus 200 for tellers is coincided with the teller who operates the teller terminal 110 or 120 or 130 requesting the service, and thus even though the financial apparatus 200 for tellers requests multiple services, it is prevented that the services are confused with one another.

Further, in the controlling method of the financial apparatus for tellers according to the embodiment, since the teller receives the state message of the financial apparatus 200 for tellers, it is possible to monitor whether the financial apparatus 200 for tellers is in the state capable of performing the service, and also the financial apparatus 200 for tellers supports the direct operation of the teller when it is possible to perform the operating service, and thus it is possible to remove inconvenience of checking the state of the financial apparatus 200 for tellers.

FIG. 5 is a block diagram showing components of a financial apparatus for tellers according to another embodiment of the present disclosure.

Referring to FIG. 5, a financial apparatus 300 for tellers according to the second embodiment of the present disclosure includes a determination part 310 which receives a service request from at least one teller terminal (e.g., 110) and determines a service type, a controlling part 320 which performs different processes according to the service type, a performing part 330 which transmits a command for performing the requested service, and a service processing information storing part 340 which stores sharing information of the service performed in the financial apparatus 300 for tellers, whether the service performance is finished and so on.

When receiving the service request from at least one teller terminal (e.g., 110), the determination part 310 checks firstly the service type. As described above, the service performed through the financial apparatus 300 for tellers may be divided into the occupied service (e.g., deposit, withdrawal, bill counting, etc.) which requires the occupation of the tellers and the mechanical operation of the internal modules of the financial apparatus 300 for tellers, and the unoccupied service (e.g., inquiry) which does not request the operation of the internal modules. For example, the internal modules may be a deposit/withdrawal processing module, a card reader module, a banknote printer module, a near field communication (NFC) module and so on.

The determination part 310 checks whether the requested service is the occupied service or the unoccupied service and transmits the service type to the controlling part 320.

If the requested service is the unoccupied service, the controlling part 320 does not transmit the service request to the performing part 330 because the operation of the internal modules of the financial apparatus 300 for tellers is not required, but confirms desired information from the service processing information storing part 340 and then responds to the teller terminal 110. Since the unoccupied service is to retrieve and confirm information stored in the service processing information storing part 340 without the operation of the internal module and the occupation of the apparatus, it may be performed regardless of whether the financial apparatus 300 for tellers is occupied. Therefore, the controlling does not request the service performance from the performing part 330, but autonomously obtains information and then transmits the information to the teller terminal 110. Thus, it is possible to maximize the task processing efficiency.

If the requested service is the occupied service, the determination part 310 confirms the occupation state of the financial apparatus 300 for tellers, and the controlling part 320 determines whether the service may be performed, based on the confirmation result. That is, in case of the occupied service, it is essential to occupy the financial apparatus 300 for tellers. Therefore, when the financial apparatus 300 for tellers is already occupied by another teller, the ‘service performing impossibility’ message as an example may be transmitted to the teller terminal 110. In other words, the occupied service may be performed only when the financial apparatus 300 for tellers is not occupied, and if the service may be performed, the controlling part 320 transmits information of the service request to the performing part 330.

After receiving the service request of the occupied service from the controlling part 320, the performing part 330 transmits a command so that the financial apparatus 300 for tellers performs the requested service. The financial apparatus 300 for tellers performs the occupied service on the basis of the command transmitted from the performing part 330, and after the service performance is finished, the controlling part 320 reflects information of finishing the service performance to the service processing information storing part 340 and thus updates the sharing information. For example, in case of the occupied service, the finished information may be updated in real time, when the service performance is finished.

The service processing information storing part 340 is a kind of database which stores processing information of the service performed by the controlling part 320 or the performing part 330, receives latest information from a processor whenever the service performance is finished and thus updates the stored information with the latest information. The information stored in the service processing information storing part 340 is shared by the controlling part 320 and performing part 330. The stored information may include information of the occupation state, processing service information, processed service information, information of the teller terminal which uses the financial apparatus 300 for tellers, and so on.

As described above, in case of the occupied service, if the occupied service is finished, the service processing information storing part 340 receives the processed result from the controlling part 320 and performing part 330 and updates the database. Meanwhile, in case of the unoccupied service, the service processing information storing part 340 may be updated periodically so that an information change according to the performance of the occupied service may be applied. In other words, the controlling part 320 checks periodically information on the service and service processing performed in the financial apparatus 300 for tellers and updates the service processing information storing part 340. Since the service processing information storing part 340 is updated periodically, the latest information may be reflected to the sharing information, and the service processing state may be integratedly managed in one database regardless of the service type.

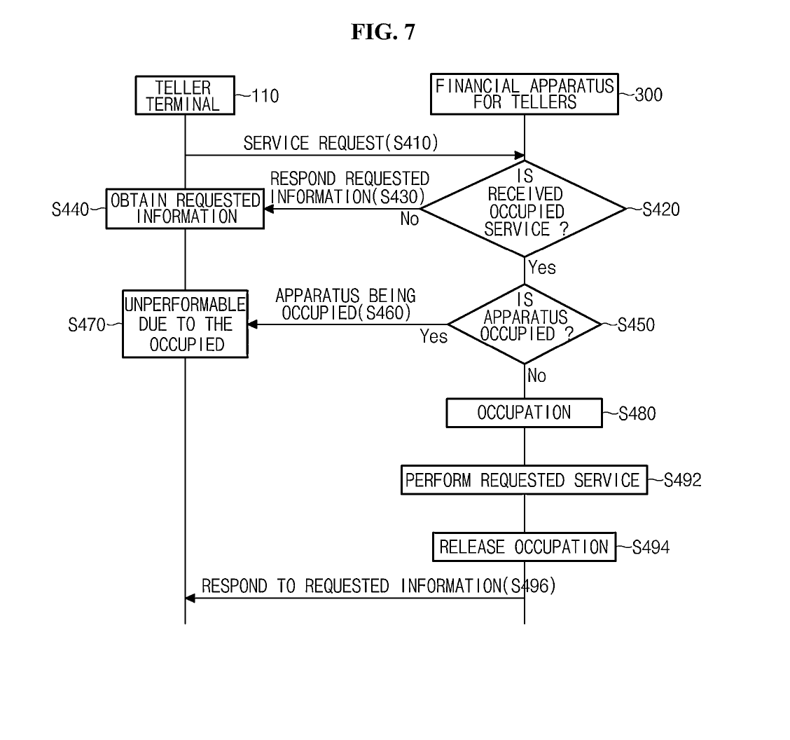

FIG. 6 is a flow chart showing a method of controlling the financial apparatus for tellers according to the other embodiment of the present disclosure. For convenience of explanation, it will be described with reference to the configuration of FIGS. 1 and 5.

In FIG. 6, the method of controlling the financial apparatus for tellers will be described by using a flow chart showing the operation of the financial apparatus 300 for tellers with respect to at least one teller terminal.

First of all, at least one teller terminal 110, 120, 130 connected with the financial apparatus 300 for tellers through a communication network may transmit the operating service or non-operating service, and the financial apparatus 300 for tellers receives at least one service request (S310). When the service request is received, the determination part 310 of the financial apparatus 300 for tellers checks whether the received service is the operating service or non-operating service (S320). As described above, the service performed through the financial apparatus 300 for tellers may be divided into the occupied service (e.g., deposit, withdrawal, bill counting, etc.) and the unoccupied service (e.g., inquiry).

If the received service is the unoccupied service, the controlling part 320 does not transmit the service request to the performing part 330, but requests, retrieves and obtains information in the service processing information storing part 340 (S330). The controlling part 320 obtains the information requested by the teller terminal 310 and then transmits it to the teller terminal 310, thereby transmitting a response to the teller terminal 310. As an embodiment, if the change in information (e.g., available money) is occurred by the unoccupied service, the controlling part 320 may update the latest information in the service processing information storing part 340 (S390). As another embodiment, when a simple inquiry service is performed, the step 390 of updating the service processing information storing part 340 may be omitted.

However, if the received service is the occupied service, it is determined whether the financial apparatus 300 for tellers is occupied (S340). If the financial apparatus 300 for tellers is occupied by another teller, the ‘service performing impossibility’ message as an example is transmitted in order to inform the fact that the occupied service may not be performed now (S350). If the financial apparatus 300 for tellers is not occupied, the controlling part 320 requests performance of the occupied service to the performing part 330 (S360). The performing part 330 that receives the service request transmits a service performing command so that the financial apparatus 300 for tellers performs the service (S370). When the service performance is finished, information of finishing the service performance is transmitted to the teller terminal 310 (S380) and then reflected to the service processing information storing part 340, thereby updating the information in real time (S390).

As described above, because the financial apparatus 300 for tellers receives the service request, checks the service type and then performs the process, it is possible to efficiently process the service according to its characteristic, and it is also possible to perform the occupied service and the unoccupied service in parallel and thus process the multiple tasks.

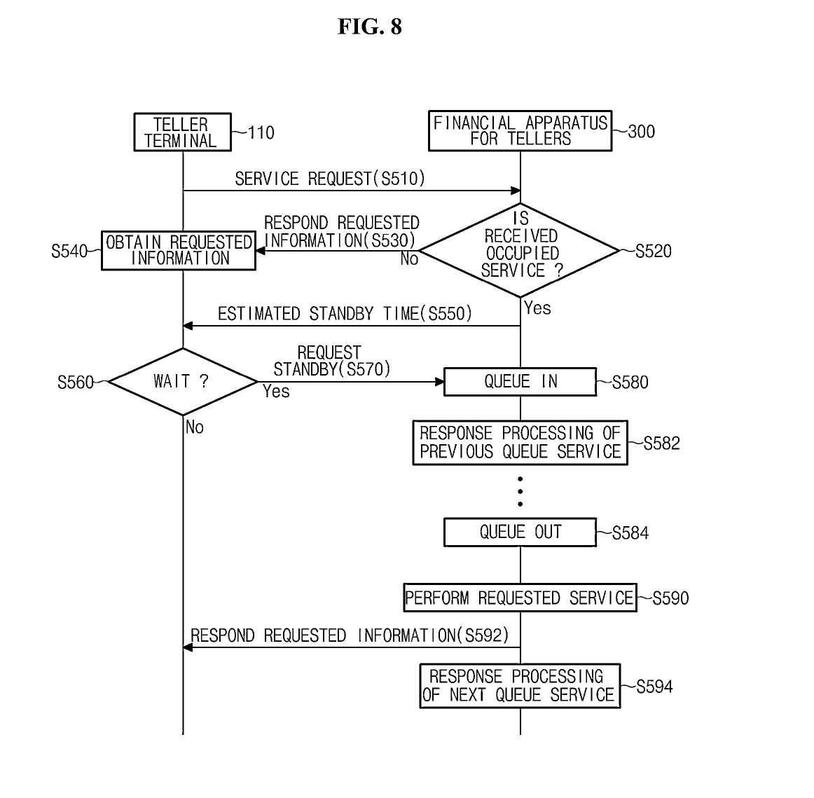

FIG. 7 is a swimlane diagram showing another method of controlling the financial apparatus for tellers according to the other embodiment of the present disclosure, and FIG. 8 is a swimlane diagram showing another embodiment in which the service requests are queue-managed by the financial apparatus for tellers.

Referring to FIG. 7, like in the controlling method of FIG. 6, after receiving the service request from the teller terminal 110 (S410), it is determined whether the received service is the occupied service or the unoccupied service (S420). If it is the unoccupied service, the controlling part 320 obtains the requested information from the sharing information stored in the service processing information storing part 340 and then immediately responds to the teller terminal 110 (S430), and thus the teller terminal 110 may obtain the requested information (S440).

However, if it is the occupied service, it is confirmed whether the financial apparatus 300 for tellers is occupied. If the financial apparatus 300 for tellers is occupied (S460), the service performing impossibility message is informed to the teller terminal (S470). If the financial apparatus 300 for tellers is not occupied, the occupation of the financial apparatus 300 for tellers is allowed (S480), and the requested service is performed (S492). If the requested service performance is finished, the occupation of the financial apparatus 300 for tellers is released (S494), and the information requested by the teller terminal 110 is transmitted (S496). The embodiment of FIG. 7 is a method of processing the service in real time. Herein, it is informed whether the services may be performed now, and if possible, the occupied service and unoccupied service are processed in parallel.

However, in the embodiment of FIG. 8, it is configured so that the multiple service requests may be stood by in the queue management manner and the multiple services may be automatically processed in turn.

Like in the embodiment of FIG. 7, if the teller terminal 110 transmits the service request (S510), the financial apparatus 300 for tellers receives the service request and then checks whether the received service is the occupied service (S520). If the received service is the unoccupied service, the requested information is immediately obtained and then transmitted to the teller terminal (S530, 540).

Meanwhile, in case that the received service is the occupied service, if the financial apparatus 300 for teller is in the unoccupied state, the controlling part 320 may perform the service in real time. However, if the financial apparatus 300 for teller is in the occupied state, the controlling part 320 calculates estimated waiting time and then informs it (S550). After receiving the estimated waiting time, the teller terminal 110 determines whether to wait (560), and if it is determined to wait and then process, the standby request is transmitted to the financial apparatus 300 for tellers (S570). If the financial apparatus 300 for tellers receives the standby request (or agreement with the estimated waiting time), the corresponding service request is stored, in turn, in a queue storing part (not shown) (S580). If the response processing of a previous queue service is finished in turn (S582) and then a turn of performing the corresponding service comes around, the stored queue is imported and the requested service is performed (S584, S590). Herein, because the service requests are stored in turn, the foremost stored service is firstly performed in the first-in first-out manner.

If the requested service performance is finished, the requested information is transmitted to the teller terminal 110 which requests the corresponding service (S592), and a next pending service is automatically performed. Due to the above-mentioned queue management manner, multiple services may be automatically processed in turn, even though it is impossible to process them in real time.

Until now, because only the preferred embodiments are described in order to help understand of the present disclosure, the construction elements, connection and relationship among them, and functions thereof described in the specification are just examples. In the present disclosure, the financial apparatus 200, 300 for tellers may be various types of office automation equipment for tellers installed in a bank, a public office and so on. The teller terminal 110, 120, 130 may be embodied in the form of various types of computing devices such as a smart phone, a smart pad, a tablet PC and a PDA. Further, in the specification, the construction components 210, 220, 230, 240 and 310, 320, 330, 340, 350 of the financial apparatus 200, 300 for tellers are embodied to be integrated physically, but if necessary, they may be embodied to be divided physically or embodied so that one or more construction components are integrated.

Furthermore, the construction components of the system may be connected to one another through digital data communication (e.g., communication network) of a certain type or medium. The communication network includes an NFC (Near Field Communication) network, a LAN (Local Area Network), a WAN (Wide Area Network), the Internet and so on.

In the embodiments of the present disclosure, all of the construction components are coupled in one unit or operated in on unit, but the present disclosure is not limited to them. That is, in the scope of the present disclosure, all of the construction components may be selectively coupled in one or more units. Further, all of the construction components may be respectively embodied as independent hardware, and also a part or whole of the construction components may be selectively combined so as to be embodied as a computer program having program modules for performing a part of whole of functions, which are combined in one or multiple hardware. The codes and code segments of the computer program would be facilely estimated by a person skilled in the art. The computer program is stored in a computer readable media, and read and executed by a computer, thereby embodying the embodiment of the present disclosure. A storing medium of the computer program includes a magnetic recording medium, an optical recording medium, a carrier wave medium and so on.

It is understood that terms “comprises”, “comprising”, “includes” or “has” intend to indicate the existence of features, numerals, steps, operations, elements and components described in the specification or the existence of the combination of these, and do not exclude the existence of one or more other features, numerals, steps, operations, elements and components or the existence of the combination of these or additional possibility beforehand. Unless specifically defined otherwise, all terms including technical and scientific terms used herein have the same meaning as commonly understood by one of ordinary skill in the art to which this disclosure belongs. It should be understood that terms generally used, which are defined in a dictionary, have the same meaning as in a context of related technology, and the terms are not understood as ideal or excessively formal meaning unless they are clearly defined in the application.

In the financial apparatus according to one embodiment of the present disclosure, since the occupied service and the unoccupied service are distinguished and processed differently, the service requests may be processed in parallel and the multiple service requests may be efficiently processed. Particularly, in case of the unoccupied service, in the conventional art, since the service was performed regardless of its type, there was a limitation that the waiting time becomes long, even though the operation of the internal module is not needed. However, since the present disclosure is configured so that the unoccupied service is separated from the occupied service and not passed through the operation performance process of the internal module, it is possible to reduce the waiting time and service processing time.

Further, In the financial apparatus according to one embodiment of the present disclosure, the multiple teller terminals or the remote teller terminal may be supported to use the financial apparatus while monitoring the state of the financial apparatus, and even though the financial apparatus may not be used now, the service requests are stored in the standby state, and thus it is possible to remove inconvenience of requesting the service again and also efficiently process the task.

The above embodiments of the present disclosure are illustrative and not limitative. Various alternatives and equivalents are possible. The disclosure is not limited by the type of deposition, etching polishing, and patterning steps describe herein. Nor is the disclosure limited to any specific type of semiconductor device. For example, the present disclosure may be implemented in a dynamic random access memory (DRAM) device or non volatile memory device. Other additions, subtractions, or modifications are obvious in view of the present disclosure and are intended to fall within the scope of the appended claims.

What is claimed is:

1. A financial apparatus comprising:
a transmitting/receiving part configured to receive a service request from at least one teller terminal and transmits a state message corresponding to the received service request to the teller terminal; and
a controlling part configured to determine whether it is in a state capable of performing a service, when the service request is received, and output a service performing possibility message to the transmitting/receiving part, if it is in a state capable of performing the service, and output a standby message to the transmitting/receiving part, if it is in a state not capable of performing the service.

2. The apparatus in claim 1, wherein the service comprises an occupied service and an unoccupied service, and
the occupied service is a service which is performed by an operation of internal module of the apparatus, and the unoccupied service is a service which is performed without an operation of the internal module of the apparatus.

3. The apparatus in claim 2, wherein, when the requested service is the unoccupied service, the controlling part performs the requested service regardless of whether the financial apparatus is in the state capable of performing the service.

4. The apparatus in claim 2, wherein, when the financial apparatus performs the occupied service, the controlling part determines that it is in the state not capable of performing the service, and
when the financial apparatus performs the unoccupied service the controlling part determines that it is in the state capable of performing the service.

5. The apparatus in claim 1, further comprising a standby request storing part configured to store the received service request in turn, when it is in the state not capable of performing the service.

6. The apparatus in claim 5, wherein, if the state not capable of performing the service is converted into the state capable of performing the service, the controlling part imports the service request stored in the standby request storing part and then performs the requested service.

7. The apparatus in claim 6, wherein the controlling part imports, in turn, at least one service request stored in the standby request storing part and then performs the requested service.

8. The apparatus in claim 1, further comprising an ID identifying part configured to identify an ID of the teller terminal from the received service request and confirm whether the ID exists in a previously stored teller ID list, and
the controlling part transmits the state message on the basis of the identified ID to the transmitting/receiving part.

9. The apparatus in claim 8, further comprising an inputting part configured to input ID,
wherein the controlling part performs the requested service when the input ID is coincided with the ID identified from the received service request.

10. The apparatus in claim 1, further comprising a displaying part configured to display processing information of a processing service out of the received service requests,
wherein the processing information comprises information of the processing service and information of the teller terminal information which requests the processing service.

11. A financial apparatus comprising:
a determination part configured to receive a service request from at least one teller terminal and determine a service type from the received service request;
a controlling part configured to perform an occupied service process or an unoccupied service process according to the determined service type; and
a service processing information storing part configured to store information of the performed service,
wherein, when service performance is completed, the controlling part transmits service performance completion information to the teller terminal which transmits the service request and also updates service processing information in the service processing information storing part in real time.

12. The apparatus in claim 11, wherein the controlling part further comprises a performing part configured to output a service performing command and make the requested service be performed, and
the controlling part transmits the service request to the performing part, when performing the occupied service process, and the performing part outputs an occupied service performing command according to the service request and make the requested occupied service be performed.

13. The apparatus in claim 11, wherein, when performing the unoccupied service process, the controlling part requests/obtains information of the unoccupied service to/from the service processing information storing part and then transmits processing completion information to a teller terminal, which transmits the service request, based on the obtained information of the unoccupied service.

14. The apparatus in claim 13, wherein the service processing information storing part updates periodically processing information of the occupied or unoccupied service from the controlling part.

15. The apparatus in claim 11, wherein, when performing the occupied service process, the controlling part confirms an occupation state and transmits an service performing impossibility message to the teller terminal, if the financial apparatus is occupied and the requested service is occupied service request, and transmits the occupied service request to the performing part in order to perform the occupied service, if the financial apparatus is not occupied and the requested service is occupied service request.

16. The apparatus in claim 15, wherein, when performing the occupied service process, the controlling part calculates an estimated waiting time for performing the service and then transmits the estimated waiting time to the teller terminal.

17. The apparatus in claim 16, wherein the service request is stored when a standby request is received from the teller terminal.

18. The apparatus in claim 18, wherein the stored service is performed in turn when previous service performance is finished.

19. A method of controlling a financial apparatus, comprising:
receiving a service request from at least one teller terminal;
determining a service type from the received service request; and
performing an occupied service process by a controlling part according to the determined service type,
wherein the performing-an-occupied-service-process comprises,
outputting a command for performing the occupied service by a performing part according to the received service request and performing the requested occupied service;
transmitting service performance completion information to the teller terminal which transmits the service request when the service is completed; and
updating service processing information in the service processing information storing part by the controlling part in real time.
